(19) United States
(12) Patent Application Publication
(10) Pub. No.: US 2023/0158391 A1
(43) Pub. Date: May 25, 2023

(54) SIGNAL COMMUNICATION SYSTEMS FOR COMMMUNICATING INFORMATION TO AND BETWEEN PARTICIPANTS OF AN EVENT AND RELATED METHODS

(71) Applicant: Sign Shield LLC, Cary, NC (US)

(72) Inventor: Robert Padula, Cary, NC (US)

(21) Appl. No.: 17/993,376

(22) Filed: Nov. 23, 2022

Related U.S. Application Data
(60) Provisional application No. 63/282,833, filed on Nov. 24, 2021.

(51) Int. Cl. A63B 71/06; G06F 3/041; G06F 3/01; A63B 71/12

(52) U.S. Cl. CPC A63B 71/0622; G06F 3/041; G06F 3/016; A63B 71/12; H04W 84/18

(57) ABSTRACT

A signaling system for wirelessly transmitting private signals between participants of an event is provided. The signaling system includes an indicator positioned in the apparel of a first participant, and an actuator positioned in the apparel of a second participant. The indicator including a signaler, an indicator processor, and a wireless receiver. The actuator including a button, an actuator processor, and a wireless transmitter. The actuator processor is configured to produce signal data for wireless transmission. The indicator processor is configured to electronically communicate with the signaler based on the signal data received by the wireless receiver.

### RELATED APPLICATION

The present application and presently disclosed subject matter claims the benefit of U.S. Provisional Patent Application Ser. No. 63/282,833, filed Nov. 24, 2021, the disclosure of which is incorporated herein by reference in its entirety.

### TECHNICAL FIELD

The presently disclosed subject matter is directed towards a wireless signal communication system between participants of an event. For example, in some embodiments, the wireless signal communication system can be used between a baseball pitcher and catcher.

### BACKGROUND

Sign stealing is a significant concern in professional sports, where the financial stakes are high. During game play, signals are passed between players and coaches. Most notable is the signaling between the pitcher and the catcher in baseball, which may include an elaborate system of hand and head signals between the two to determine how best to approach a batter. Generally, the pitcher looks to the catcher to provide preferences for the pitcher's pitch type and location before throwing the pitch. The pitcher may indicate an acceptance or denial of the catcher's pitch preference. For example, the catcher may indicate that an inside fastball is preferred, due to the current pitch count and the batter's history, by providing a hand signal between the catcher's legs. In this manner, the signal is protected from view from most other players, and the signaling may be difficult to decipher (though not impossible given the limited signals that a hand at that distance can provide).

Recently, there has been much controversy surrounding the elicit detection and deciphering of signals in professional sports. In baseball, sign stealing is the observing and relaying, through legal and illegal methods, of the signs being given by the opposing catcher to the pitcher or a coach to a base runner. The signs are stolen by the opposing team and then relayed to the other members of the team to give advance knowledge of what kind of pitch is coming next, thereby giving that batter an advantage. Legal sign stealing typically involves the signs being observed by a runner on second base and then relayed to the batter through some sort of gesture. Illegal sign stealing involves mechanical or electronic technology. The rules regarding use of such technology have become more stringent over time and continue to evolve. Sign stealing can occur during real-time and can provide a significant advantage when effectively deployed.

According to the unwritten rules of baseball, stealing the signs that are given by the third base coach, or those of the catcher by a baserunner on second base, are tolerated, and it is up to the team giving the signs to protect them, so they are not stolen. Similarly, stealing signs is not necessarily a violation of Major League Baseball's (MLB) rulebook, depending how the signs are stolen. The National League has banned the use of a “mechanical device” to steal signs. Even before the 2019 season, in an effort to reduce illegal sign stealing, MLB commissioner Rob Manfred instituted specific prohibitions on where teams could position cameras and how instant replay officials can communicate with managers.

What used to be quite simple, a maximum of five different signs based on putting fingers down just prior to the pitch that the batter cannot see, has become overly complex. TV cameras central to the catcher clearly show what sign is being given. Runners on second base have a clear view of the catcher's signs and can signal the batter as to what pitch is coming and where it will be thrown. As a result, most catchers now wear a wristband with complicated signal charts to help them remember the various signs and sequences. Players have notes in their hats to help them understand the new sequence of signs so they can be positioned correctly based on the location and type of pitch. All these factors have caused frequent stoppages of play in which the catcher calls time out and walks to the pitcher's mound to discuss signs and sequence. Pitchers often ask the catcher to repeat the series of signs because they missed the key signal. All this leads to the catcher's signals or signs to the pitcher being one of the most time consuming and troublesome issues that lengthens the time of the game making it feel to a fan/viewer that the game is dragging on.

Voice command technology is now being used, but it is complicated by the number of combinations that must be learned. The biggest issue is the reason catchers do not simply have a microphone. It is because sometimes the batter can hear the signal. There is a volume adjustment for the catcher, but if it is turned up too high, the batter will hear the sign. If it is too low, the players cannot hear the signal, particularly with a raucous crowd. As an example, Major League Baseball (MLB) introduced voice command technology to the pitcher-catcher communication in an effort to battle sign stealing, which was generally seen as a positive move for the game. MLB did not check to see how the technology would respond in a significantly louder postseason atmosphere, like in postseason-playoff environments. For example, Mets pitchers ran into a problem with the technology in a NL Wild Card game against the Padres. With the Padres' home crowd on their feet and making noise, the Mets pitcher was seen audible asking the catcher what pitch to throw. He simply could not hear the voice command technology feed over a playoff-caliber crowd.

Light technology is innovative, but it runs the risk of having center field TV cameras give away the signal and may be as susceptible to sign stealing as the hand signs given now. Not to mention the first and third base coaches and the other team's bullpen.

Accordingly, there remains a need for a system and method of use that addresses the various disadvantages associated with current signaling in professional sports.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Further, the claimed subject matter is not limited to implementations that solve any or all disadvantages noted in any part of this disclosure.

According to at least one embodiment of the disclosed subject matter, a signaling system is provided. The system includes an indicator positioned in the apparel of a first participant, the indicator including a signaler, an indicator processor, and a wireless receiver; an actuator positioned in the apparel of a second participant, the actuator including a button, an actuator processor, and a wireless transmitter, wherein the actuator processor is configured to produce signal data for wireless transmission, and wherein the indicator processor is configured to electronically communicate with the signaler based on the signal data received by the wireless receiver.

According to at least one embodiment of the disclosed subject matter, a method of operating the signaling system is provided. The method includes an actuator processor converting haptic data received from a button into signal data; wirelessly transmitting the signal data from a wireless transmitter positioned in apparel of a second participant to a wireless receiver positioned in apparel of a first participant; converting the signal data into indicator data for electrical communication with a signaler; and activating the signaler using the signal data.

### BRIEF DESCRIPTION OF THE DRAWINGS

The foregoing, as well as the following Detailed Description of example embodiments, is better understood when read in conjunction with the drawings included herein. Thereby, a full and enabling disclosure of the present subject matter including the best mode thereof to one of ordinary skill in the art is set forth more particularly in the remainder of the specification, including reference to the accompanying figures, in which:

FIG. 1 illustrates a top perspective view of embodiments of indicators and actuators of a signaling system according to the present subject matter;

FIG. 2 illustrates a schematic view of an embodiment of the signaling system that forms a mesh network in use on a baseball field according to the present subject matter;

FIG. 3A illustrates a top plan view of embodiments of indicators of a signaling system according to the present subject matter;

FIG. 3B illustrates a schematic view of another embodiment of an indicator of a signaling system according to the present subject matter;

FIG. 3C illustrates a view of an interior portion of an embodiment of an article of apparel, i.e., a baseball cap, with an embodiment of an indicator of a signaling system positioned within the article of apparel according to the present subject matter;

FIG. 4A illustrates a schematic view of embodiments of actuators of a signaling system according to the present subject matter;

FIG. 4B illustrates a cross-sectional view of an embodiment of a touch interface or button of an actuator according to one or more embodiments of the presently disclosed subject matter;

FIG. 4C illustrates a schematic view of an embodiment of an actuator of a signaling system according to the present subject matter;

FIG. 4D illustrates a side view of a baseball catcher wearing an article of apparel with an embodiment of an actuator of a signaling system positioned on the article of apparel according to the present subject matter;

FIG. 5 is schematic view of the communication of signals according to one or more embodiments of the presently disclosed subject matter;

FIG. 6A is a perspective view an embodiment of an article of apparel with an embodiment of an indicator therein according to one or more embodiments of the presently disclosed subject matter; and

FIG. 6B is a perspective view an embodiment of an article of apparel with an embodiment of an actuator therein according to one or more embodiments of the presently disclosed subject matter;

FIG. 7 illustrates a top perspective view of an embodiment of an actuator, such as a touch screen computing device with an actuator converter engaging the computing device, of a signaling system according to the present subject matter;

FIG. 8 illustrates a perspective view of another embodiment of an actuator, such as a touch screen computing device with an actuator converter engaging the computing device, of a signaling system according to the present subject matter; and

FIG. 9 illustrates a top perspective view of an embodiment of an actuator, such as a touch screen computing device with a signaling system software downloaded thereon, of a signaling system according to the present subject matter.

Repeat use of reference characters in the present specification and drawings is intended to represent analogous features or elements of the present subject matter.

### DETAILED DESCRIPTION

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Although the terms first, second, right, left, front, back, top, bottom, etc. may be used herein to describe various features, elements, components, regions, layers and/or sections, these features, elements, components, regions, layers and/or sections should not be limited by these terms. These terms are only used to distinguish one feature, element, component, region, layer or section from another feature, element, component, region, layer, or section. Thus, a first feature, element, component, region, layer, or section discussed below could be termed a second feature, element, component, region, layer, or section without departing from the teachings of the disclosure herein.

Similarly, when a feature or element is being described in the present disclosure as “on” or “over” another feature or element, it is to be understood that the features or elements can either be directly contacting each other or have another feature or element between them, unless expressly stated to the contrary. Thus, these terms are simply describing the relative position of the features or elements to each other and do not necessarily mean “on top of” since the relative position above or below depends upon the orientation of the device to the viewer.

Embodiments of the subject matter of the disclosure are described herein with reference to schematic illustrations of embodiments that may be idealized. As such, variations from the shapes and/or positions of features, elements, or components within the illustrations as a result of, for example but not limited to, user preferences, manufacturing techniques and/or tolerances are expected. Shapes, sizes and/or positions of features, elements or components illustrated in the figures may also be magnified, minimized, exaggerated, shifted, or simplified to facilitate explanation of the subject matter disclosed herein. Thus, the features, elements or components illustrated in the figures are schematic in nature and their shapes and/or positions are not intended to illustrate the precise configuration of the subject matter and are not necessarily intended to limit the scope of the subject matter disclosed herein unless it specifically stated otherwise herein.

It is to be understood that the ranges and limits mentioned herein include all ranges located within the prescribed limits (i.e., subranges). For instance, a range from about 100 to about 200 also includes ranges from 110 to 150, 170 to 190, 153 to 162, and 145.3 to 149.6. Further, a limit of up to about 7 also includes a limit of up to about 5, up to 3, and up to about 4.5, as well as ranges within the limit, such as from about 1 to about 5, and from about 3.2 to about 6.5.

“Smart device,” or “mobile smart device,” as used herein means any mobile electronic device configured with imaging and/or computing capabilities that can process image and sensor data. Such smart devices can include, but are not limited to, at least one of a mobile smartphone, a personal digital assistant (PDA), a computing tablet, a personal media player, or any like mobile electronic device configured with imaging and/or computing capabilities. In some embodiments, the smart device may be provisioned with a hardware-based processor that is configured to execute software programs or applications.

“Touch interface(s)” as used herein mean components that are touched to generate messaging information to be processed by a processor within an actuator to generate signal data that can then be sent to an indicator. Touch interface(s) can include by are not limited to physical, mechanical buttons, haptic screen buttons, cap touch buttons, touch screens, or the like.

“Actuator” as used herein means a device that can be used to electronically send information, such as one or more signals, to one or more receiving devices and can include, but is not limited to, a computing device such as a personal or laptop computer or tablet computer, a smart device or mobile smart device, a transmitter or transceiver, such a signal transmitter with one or more buttons thereon. As used herein, “actuator” can also include software that can be loaded onto a computing device or smart device the software can be downloadable software or can be uploaded to a computing device or smart device via actuator converter, such as a dongle, USB stick, or the like.

“Indicator,” as used herein, means a device that can receive one or more signals from an actuator and provide a message, such as a vibration or other signal, and can include, but is not limited to, a receiver or transceiver device, a smart device, or the like.

“Computing device(s),” as used herein means one or more laptop computers, set-top devices, tablet computers, mobile devices, mobile smart devices, smartphones, wearable devices, and/or the like and includes, but is not limited to any mobile electronic device configured with imaging and/or computing capabilities. Such computing devices can include, but are not limited to, at least one of a mobile smartphone, a personal digital assistant (PDA), a computing tablet, a laptop computer, or any like mobile electronic device configured with imaging and/or computing capabilities. In some embodiments, the computing device may be provisioned with a hardware-based processor that is configured to execute software programs or applications.

“Software” or “Software application” as used herein means a computer program product for and used on a computer, which can include, but is not limited to a mobile computing device or a vehicle computing device with interactive capabilities, that can be in the form of a non-transitory computer readable media comprising computer executable instructions embodied in a computer readable medium that when executed by a processor of a computer can control of the computer such that the computer can perform specific steps.

The signal systems and methods disclosed herein can be used in a variety of different ways and can be useful in a variety of different events, missions, or scenarios. The signal systems and methods disclosed herein do not have to deal with volume, memorizing voice commands, having to circumvent TV cameras, base coaches, or the bullpen gang. Haptic technology is totally hidden and undetectable. Plus, the simplicity of pushing a button that signifies a hand signal for the inside or outside corner is a short learning curve for all players involved. For simplicity, the signaling system will be described primarily herein in reference to the sporting event of baseball. The signal systems and methods disclosed herein provide simple apparatuses, systems, and methods for use in baseball for getting back to the 1-2-3-4-5 signals quickly and easily without having to mask the signals in an elaborate way. In one embodiment, one or more actuators that can be used by a catcher and/or a manager in the dugout and an indicator worn by the pitcher and a plurality of indicators worn by the other players in the field. The actuators can each comprise a touch interface, an actuator processor, and a transceiver or transmitter. The actuator used by the catcher can be concealably attached to the inner face of the chest padding. The actuator used by the catcher can be small, like a garage door opener, and can be used anywhere the catcher finds comfortable such as his shin guards, behind the chest protector, on his wrist, etc. The indicators can each comprise a transceiver or receiver and an indicator processor flexibly connected with two small signalers that can be placed in the baseball caps of the players on the field, including the pitcher, such that the signalers are located on either side of the respective baseball caps. The manager of the team in the dugout or the catcher can press the touch interface on the respective actuator, which can be a button, for example, 1-2-3-4-5 times to signal the pitch. The pitcher feels the pulses, or vibrations, in his baseball cap and knows what pitch to throw. For example, for a righthanded batter, if the indicator generates a pulse, or vibration, on the left side of the pitcher's baseball cap, the pitcher knows to pitch an outside pitch. Alternatively, if the indicator generates a pulse, or vibration, on the right side of the pitcher's baseball cap, the pitcher knows to pitch an inside pitch to the righthanded batter. Additionally, in some embodiments, all fielders can have an indicator as well so that the infielders and outfielders can also receive the signal from the actuator(s) which is different from currently used technology.

The signals are encrypted and wireless. The encryption code used on the signals can be changed every few seconds and is virtually impossible to hack. They have the additional advantage of being shared with every player on the field and only given once. No need for elaborate signals, no need to visit the pitcher's mound, no need to worry about sign stealing, no need for the pitcher to paint their fingernails so the pitcher can see the signs better. The actuator and the indicator can provide wireless communication between the indicators in proximity of each other in a mesh network. In the context of baseball, the mesh network can allow the nine players on the field and coaches in the dugout and on the field to share the same signal at the same time. All players wearing an indicator would receive the signal transmitted from an actuator if the indicators and the players wearing the indicators are in a certain proximity to another actuator or indicator of the device. The distance between all of these individuals on a baseball field, even in the event of a “shift,” would allow all to share communication at the same time. A wireless mesh architecture provides cost effective and low mobility over a specific coverage area. Wireless mesh infrastructure is, in effect, a network of routers minus the cabling between nodes. It is built of peer radio devices that do not have to be cabled to a wired port like traditional WLAN access points (AP) do. Mesh network infrastructure can carry data over large distances by splitting the distance into a series of short hops. Intermediate nodes not only boost the signal, but cooperatively pass data from point A to point B by making forwarding decisions based on their knowledge of the network, i.e., perform routing by first deriving the topology of the network.

The devices and systems use encrypted RF signaling technology that can be transmitted from an actuator where the touch interface is pressed or activated. The receiver of the indicator receives the transmitted RF signal. The indicator processor processes the signal and sends a haptic feedback signal to one of the signalers as indicated in the transmitted RF signal to cause the signaler to generate a unique vibration. The designation of the signaler to vibrate and the number of vibrations conveys information to the player that wears the indicator. The number of vibrations generated by a signaler of the indicator can correspond to the type of pitch. For example, a single (1) vibration can indicate to the pitcher to pitch a fastball, while two (2) vibrations can indicate to the pitcher to pitch a curveball. Three (3) vibrations can indicate to the pitcher to pitch a change-up, while four (4) vibrations can indicate to the pitcher to pitch a splitfinger and five (5) vibrations can indicate to the pitcher to pitch a slider. The indication of which side of the plate that the pitch is to be thrown can be indicated by the location of the opposing signaler that the pitcher wears. Additionally, when used in baseball, the signaling system can be used on offense giving hitters and runs signals as to what the managers or coaches want to the player to do.

The actuator that can be used by the manager in the dugout can be a smart device, such as a smartphone or a tablet device. The actuator that can be used by the catcher can be a smaller device that be clipped or attached to his uniform. For example, in some embodiments, the actuator can be clipped to or attached to the inward facing portion of the chest protector or under one of his pads that is easily accessible to the catcher's throwing hand. In this manner, the catcher can press the touch interface of the actuator. The actuator can be configured to provide some haptic feedback to the catcher to let the catcher know that the catcher has pressed the touch interface. The indicator processor can comprise a flexible printed circuit board made of polyimide or polyester film. The printed circuit board can be highly reliable while providing flexibility to permit the insertion of the indicator into an article of apparel. The printed circuit board can be characterized by high density, light weight, a thin thickness, and a good bendability. Ribbon connections between the opposing signalers of the indicator and the indicator processor permit the indicator to be tucked into or incorporated into an article of apparel, such as a baseball cap so that the signaler can be on the left side or the right side. Thereby, the signals can be distinctly given on either the left or right side of the user to clearly distinguish each signaled side from one another.

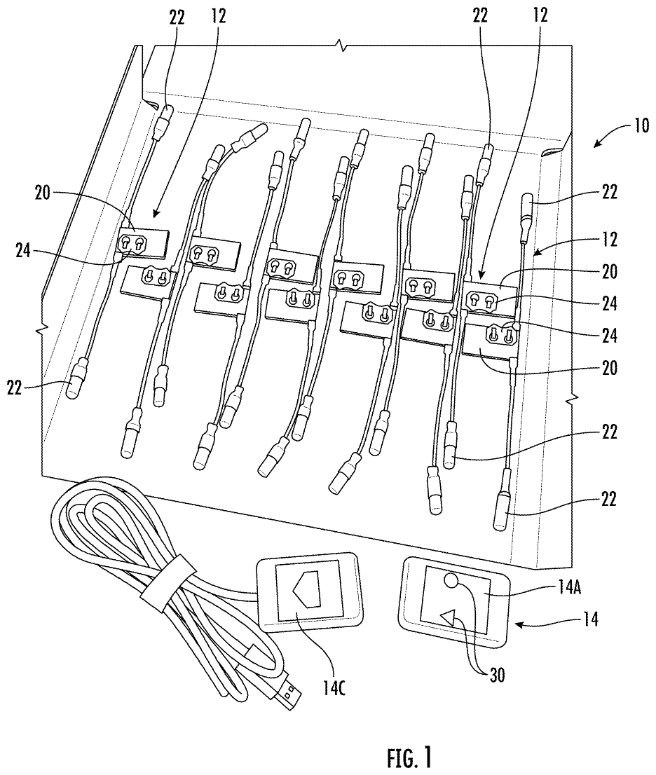

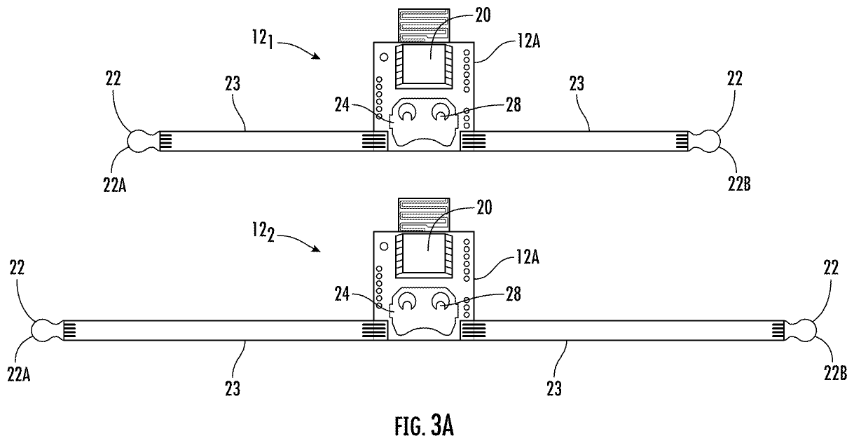

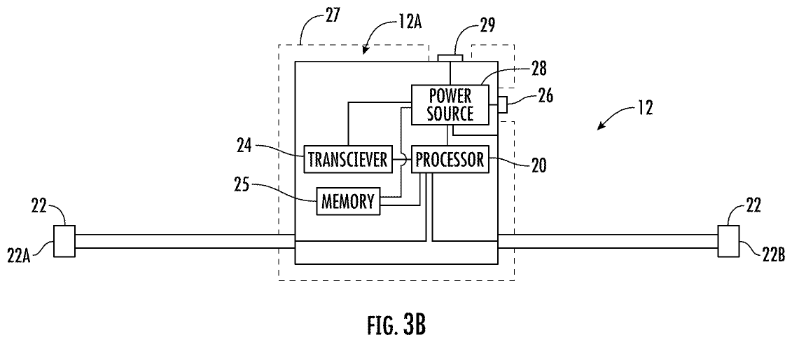

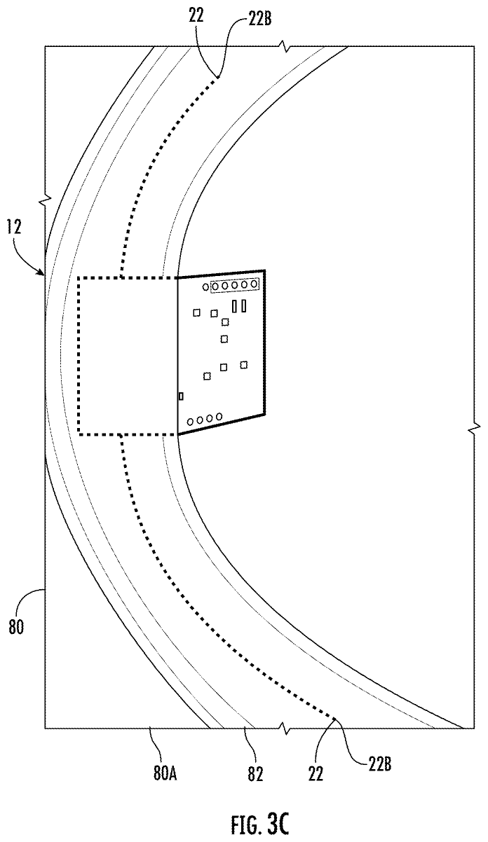

Referring to FIG. 1, a signaling system, generally designated 10, can be provided. The signaling system 10 can comprise one or more indicators 12 and one or more actuators 14 or one or more actuator converters 14C, such as a dongle or a USB stick that has software thereon that can be plugged into a tablet or other computing device to access the software. In some embodiments, the system 10 includes a plurality of indicators 12 and/or actuators 14. The system 10 can permit private communication of signals between participants of an activity by accepting, converting, and transmitting signals between the participants using the actuator(s) 14 and indicator(s) 12. Each indicator 12 can comprise an indicator processor 20, one or more signalers 22, and/or a receiver, or transceiver, 24 as shown in FIGS. 1 and 3A-3B. A user can create an originating signal on an actuator 14 as described in more detail below. The receiver 24 of each indicator 12 may be configured to receive wireless communications including the originating signal data transmitted from the actuator 14. Upon receipt of the signal data, the receiver 24 may electrically communicate the signal data to the indicator processor 20 of the indicator 12. The indicator processor 20 may be configured with software or logic to analyze the signal data received from the actuator 14 and convert the signal data into indicator data for electrical communication with the one or more signalers 22. In some embodiments, the indicator processor 20 can be in communication with a memory 25 for storing data that is generated by the processor 20. The signaler(s) 22, upon receipt of the indicator data, may effectuate one or more indications for communicating the signal data to a participant using the indicator, for example, wearing an article of apparel that incorporates the indicator 12. As stated, the receiver 24 can be a transceiver that can also transmit or relay the original signal received that originated from the actuator, herein after the “originated signal,” to other indicators within a given proximity range. In particular, the signaling system can operate as a mesh network with the various indicators 12 and actuators 14 operating as nodes within a given proximity range of each other.

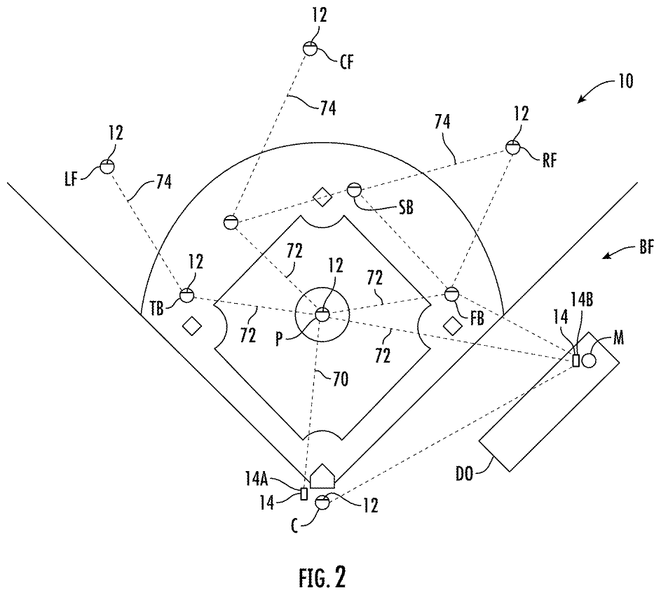

Using the sport of baseball as an example of how the signaling system 10 can operate, a baseball field BF is schematically shown in FIG. 2. A baseball team on the field BF can include a pitch P at the mound, a catcher C behind home plate, and a first baseman FB, second baseman SB, shortstop SS, and a third baseman TB in the infield as well as a left fielder LF, a center fielder CF, and a right fielder RF in the outfield. A manager, or coach, M as well as other reserve players can reside in the dugout DO. The catcher C and the coach M can each have an actuator 14. For example, the catcher C can have an actuator 14A that has touch interfaces, such as physical buttons or cap touch buttons, while the coach M can have an actuator 14B driver that can provide different or more complex features than the actuator 14A used by the catcher C. In some embodiments, the actuator 14A that the catcher uses can be physical buttons that allow the catcher to feel the button to better identify the button being pushed and to feel the button press more actively. In some embodiments, the actuator 14B used by the coach M can comprise a smart device, such as a smartphone or a tablet, or some other computing device, such as a laptop.

The pitcher P can have an indicator 12. For example, an indicator 12 could be a wearable device or can be positioned in an article of apparel such as a baseball jersey or a baseball cap. Similarly, the position players FB, SB, SS, TB, LF, CF, RF in the field can also have indicators 12. The actuators 14 and the indicators 12 can form the signaling system 10 that operates by wireless communication by which the coach M or the catcher C can send out a wireless signal from their respective actuators to the indicators 12 on the pitcher P and the other position players FB, SB, SS, TB, LF, CF, RF in the field. The indicators 12 can convert the signal received from the respective actuator into a haptic feedback that provides information to the respective players wearing the indicators.

The actuators 14 and the indicators 12 can form a mesh network 16 to provide wireless communication between the indicators in proximity of each other. The mesh network 16 can allow the players P, FB, SB, SS, TB, LF, CF, RF on the field and coach(es) M in the dugout and/or on the field to share the same signal at the same time. All players P, FB, SB, SS, TB, LF, CF, RF wearing an indicator would receive the signal transmitted from an actuator if the indicators and the players wearing the indicators are in a certain proximity range to another actuator or indicator of the signaling system. The distance between all of these individuals on a baseball field, even in the event of a “shift,” would allow all to receive the information from the communication at the same time. For example, the catcher C may use his actuator 14A to generate an originating signal 70 which can be received by the indicator 12 worn by the pitcher P. The indicator 12 worn by the pitcher P can forward the originated signal 70 as signal 72 to the indicators 12 worn by the infield players FB, SB, SS, TB while providing haptic feedback to the Pitcher P at the same time. In turn, the indicator 12 worn by the second baseman SB can forward the originated signal 70 as signal 74 to the indicator 12 worn by the right fielder RF while also providing haptic feedback to the second baseman SB; the indicator 12 worn by the shortstop SS can forward the originated signal 70 as signal 74 to the indicator 12 worn by the center fielder CF while also providing haptic feedback to the shortstop SS; and the indicator 12 worn by the third baseman TB can forward the originated signal 70 as signal 74 to the indicator 12 worn by the left fielder LF while also providing haptic feedback to the third baseman TB. In this manner, the actuators 14 and the indicators 12 can operating as the signaling system 10.

Referring to FIGS. 1, 3A and 3B to describe an example indicator 12 in more detail, in some embodiments, the indicator 12 may further include an indicator power switch 26 for enabling the indicator 12 with power, and/or an indicator power source 28 for storing and providing power to the indicator 12. The power source 28 may be a common 3V CR2016 battery with dimensions of 20 mm×1.6 mm. The indicator power source 28 may be a rechargeable battery and can have a charging port 29 that can be an external port for receiving a plug and/or a wireless charging coil. The indicator 12 may include or be essentially comprised of a flexible circuit board 12A for internal electrical communication and processing. Flexible circuitry may be used with the indicators 12 to enable ease of positioning with respect to the apparel in which it is positioned or to which it is attached and the participant. One or more of the components of the indicator 12 may be housed within an indicator housing 27 shown in dotted lines in FIG. 3B. The indicator housing 27 may be waterproof for protecting the housed components from water damage.

As shown in FIGS. 3A and 3B, the signalers 22 may be a vibrator 22A, 22B configured to provide vibrations as indications, or may be a mechanism configured to provide a tactile sensation as indications (e.g., a touch or prick or swipe). In some embodiments, the signalers 22 can be connected to the printed circuit board 12A on which the processor 20 resides by flexible circuit ribbons 23 as shown in FIG. 3A. As shown in FIG. 3A, a first indicator 12₁ can have flexible circuit ribbons 23 of a different length, i.e., shorter length, than the flexible circuit ribbons 23 of the second indicator 12₂ shown in FIG. 3A. The flexible circuit ribbons 23 may be thin, flexible strips, and may be between about 3 inches and about 7 inches in length. For example, in some embodiments, flexible circuit ribbons 23 may be about 5 inches in length. Thereby, the first indicator 12₁ and the second indicator 12₂ can be a different size with the first indicator 12₁ being a small indicator 12 and the second indicator 12₂ being a large indicator 12. In this manner, the indicators 12₁, 12₂ can be sized for different users.

As shown in FIG. 3C, in use, the indicator 12, partially shown in dashed lines, can be used in an article of apparel 80, such a hat or baseball cap 80A. For example, the indicator 12 may have its two signalers 22, which may be positioned a distance apart the sweatband 82. For instance, one signaler 22A may be positioned between the interior sweatband 82 and the exterior of the baseball cap 80A on a left side and another signaler 22B may be positioned between the interior sweatband 82 and the exterior of a hat 80A on a right side. In this manner in the context of the signaling system 10 being used in baseball, if the indicator 12 generates a pulse, or vibration, on the left side of the pitcher's baseball cap 80A, the pitcher P knows to pitch an outside pitch for a righthanded batter. Alternatively, if the indicator generates a pulse, or vibration on the right side of the pitcher's baseball cap 80A, the pitcher P knows to pitch an inside pitch for a righthanded batter.

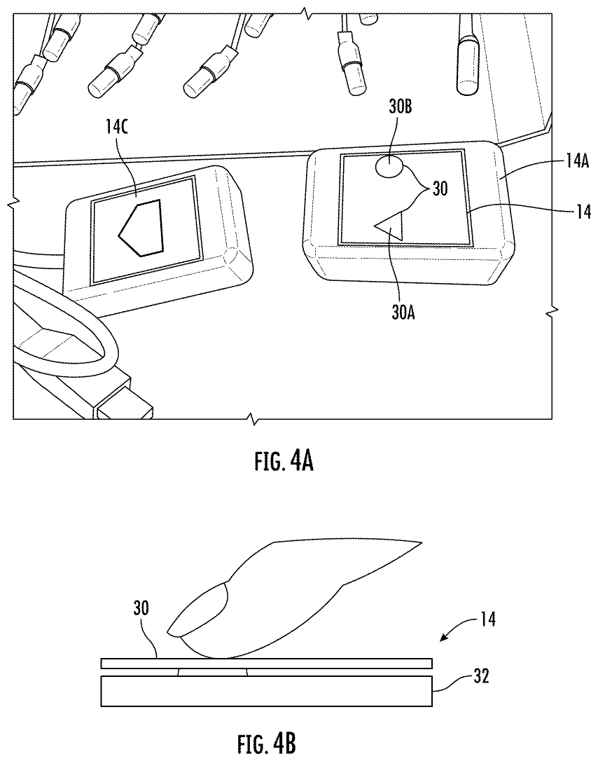

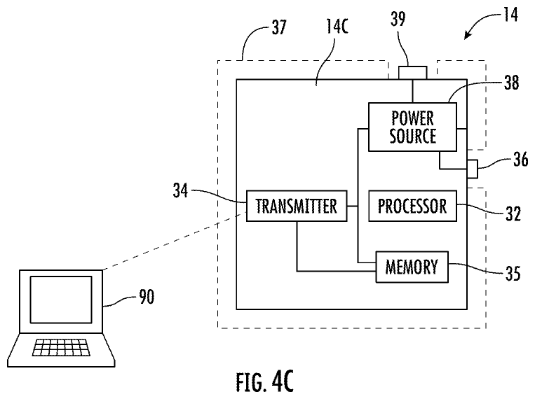

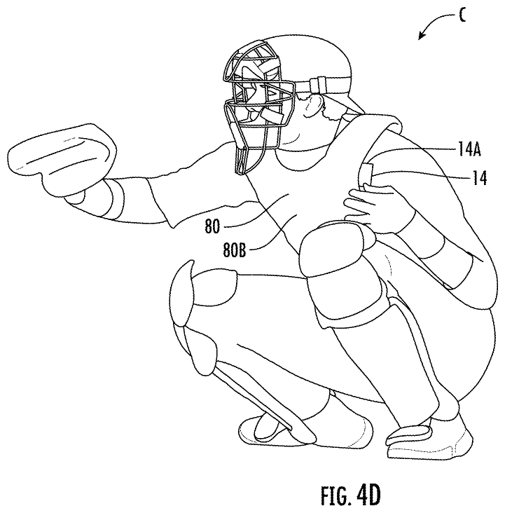

As shown in FIGS. 1 and 4A-4C, different types of actuators can be used by different types of participants. An actuator 14 may include one or more buttons, or touch interfaces, 30, an actuator processor 32, and/or a transmitter 34. The one or more buttons 30 may be activated by a first participant to create actuator data. The actuator data may be electrically communicated from the touch interfaces 30 to the actuator processor 32, which may analyze and covert the actuator data into the signal data for wireless transmission by the transmitter 34 to a receiver 24 of an indicator within a proximity range of the actuator 14. In some embodiments, the one or more touch interfaces 30 can comprise at least one of a depressible surface, a capacitive touch sensor, and/or a switch. The touch interfaces 30 may be frictionless to minimize detectable sound.

As seen in FIG. 4C, each actuator 14 may further include an actuator power switch 36 for enabling the actuator 14 with power, and/or an actuator power source 38 for storing and providing power to the actuator 14. As with the indicator, the power source 38 may be a common 3V CR2016 battery with dimensions of 20 mm×1.6 mm. The actuator power source 38 may be a rechargeable battery and can have a charging port 39 that can be an external port and/or a wireless charging coil. The actuator 14 may include or be essentially comprised of flex circuit board 14C, such as a printed circuit board for internal electrical communication and processing. Flexible circuitry may be used with the actuators 14 to enable ease of positioning with respect to the apparel in which it is positioned or to which it is attached and the participant. One or more of the components of the actuator 14 may be housed within an actuator housing 37 shown in dotted lines in FIG. 2C. The indicator housing 37 may be waterproof for protecting the housed components from water damage.

Each actuator 14 can include memory 35 for storing the signal data that is sent by transmitter 34. The signal data may remain on the memory 35 for processing by the processor 32 and/or may be wirelessly transmitted or through a hardwire connection (at a later time) to a remote device 90 for further processing and storage. The signal data may be processed to perform analytics, develop metrics and statistics, enabling predictive insights (such as predicting pitches or outcomes or incoming signals). The memory 35 may include (e.g., store, and/or the like) instructions, such as executable instructions, i.e., a software application. For example, the executable instructions can be in a memory of or accessible by a computing device, such as smart device, a tablet computing device, a laptop computer, or the like, used by a manager or coach. The executable instructions can be for facilitating the selection of the pitch and the communication of that selection to one or more indicators.

As shown in FIGS. 1, 4A, and 4D, in the context of the signaling system 10 being used in baseball, a first actuator 14A, such as a transmitter, can be provided that can be used by a catcher C. For example, the first actuator 14A can comprise a “right” button 30A and a “left” button 30B that can be pushed to send right side signals or left side signals, respective to the indicators on the other players. For instance, the “right” button 30A may have a different tactile feel as compared to the “left” button 30B. As an example, in some embodiments, the “right” button 30A may have a different shape than the “left” button 30B, so that the catcher C can differentiate the buttons 30A, 30B without looking at them so that he presses the correct button 30A, 30B to send the desired signal. In this manner, the catcher can discreetly press the correct button 30A, 30B, for example, 1-2-3-4-5 times to signal the desired pitch. As shown in FIG. 4D, in use, the actuator 14 can be used on an article of apparel 80, such as a chest protector 80B of the catcher C. The actuator 14, such as the actuator 14A shown in FIGS. 1 and 4A, can be concealably attached to the inner face of the chest padding 80B. For example, in some embodiments, the actuator 14A can be clipped to or attached to the inward facing portion of the chest protector 80B of the catcher C or under one of his pads that is easily accessible to the catcher's throwing hand.

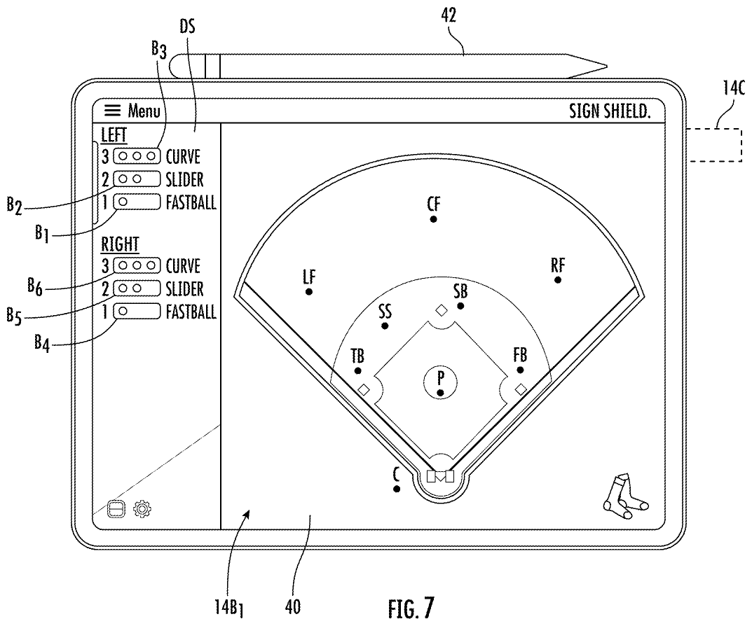

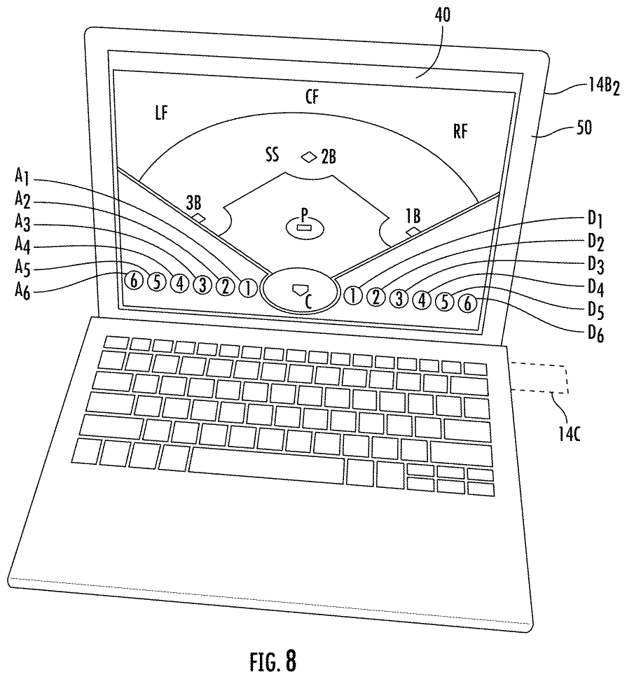

As shown in FIGS. 1, 4A, 7 and 8, in the context of the signaling system 10 being used in baseball, an second actuator that comprises an actuator converter 14C can be provided that can be used to provide access to software to a computing device, such as a computer tablet 14B₁ or a laptop computer 14B₂ that can be used by a manager or coach M. In the embodiment shown in FIGS. 1 and 4A, the actuator converter 14C can be a USB device that can be plugged into a port of a computing device. In some embodiments, the actuator converter 14C can be a dongle or a USB stick that can be plugged into a port of a computing device such as tablet as shown in FIG. 7 or a laptop computer as shown in FIG. 8.

Referring to FIG. 7, the embodiment of an actuator comprising an actuator converter 14C is shown that has provided software access to the computer tablet 14B₁ for use by a manager. The “manager's interface” on the actuator tablet 14B₁ can be a graphical user interface (“GUI” interface) 40 that can provide more options and features to the manager to control the messaging being sent by a manager. A stylus 42 can be used to interact with the GUI interface 40. The tablet 14B₁ can be a touchscreen device, such as an iPAD®, Microsoft Surface®, Android® device, or the like. Alternatively, the manager or coach may use his or her finger on the touchscreen of the actuator tablet 14B₁. Currently, managers use tablet devices such as a Microsoft and an Apple iPad to look at stats, videos, etc. in the dugout. These tablet devices can be used as actuators 14B₁ and can have a GUI interface 40 provided for controlling the signaling system 10. The GUI interface 40 on the actuator 14B₁ can be used to call pitches in situations when the managers call the pitches. In such situations, both the pitcher and the catcher as well as other players in the field can receive the signal on their indicators 12 (as shown in FIG. 2). The GUI interface 40 on the tablet devices 14B₁ can be used by the manager to signal fielders to let them know where to be in a shift in the infield or outfield. In the embodiment shown, the actuator converter 14C is used to provide access to or upload software used to create the GUI interface 40 and permit communication with the indicators 12. In some embodiments, the software may be downloadable to a computing device such as the tablet device from a website upon purchase of the signaling system 10.

As shown in the embodiment in FIG. 7, the GUI interface can be programmed to show different pitches for different pitchers. As shown in FIG. 7, the pitcher may throw three different types of pitches. The manager/coach can push different buttons B₁-B₆ call different pitches at different locations. As an example, the manager/coach can push the GUI button B₁ to call a fastball on the left side of the plate, which could be an inside pitch or an outside pitch depending on the whether the batter is right-handed or left-handed. The pitch would then receive a vibratory signal from his indicator indicating a left-side fastball, for example, a single vibratory signal from the left side signaler of the pitcher's indicator. Alternatively, the manager/coach can push the GUI button B₃ to call a curve ball or GUI button B₂ to call a slider on the left side of the plate. For a different batter and depending on the strength of the types of pitches the pitcher throws, the manager/coach can push the GUI button B₆ to call a curve ball or GUI button B₅ to call a slider on the right side of the plate, which could be an inside pitch or an outside pitch depending on the batter. Alternatively, the manager/coach can push the GUI button B₄ to call a fast ball on the right side of the plate. Upon the manager/coach pushing the different GUI buttons B₁-B₆, the pitcher would receive the appropriate signal from the indicator, which can be in the lining of the pitcher's ball cap. For a different pitcher, more and/or different types of pitches can be listed on the GUI interface 40 and appropriate signals that are to be received by the new pitcher's indicator can be received by the indicator upon the manager/coach engaging the corresponding GUI button. In some embodiments, one or more of the actuators 14B used by the coaches or manager can comprise smart phones, smart devices, computers, tablets, or other electronic devices.

Referring to FIG. 8, the embodiment of an actuator comprising an actuator converter 14C, such as a dongle or a USB stick, is shown that has provided software access to the laptop computer 14B₂ for use by a manager. The “manager's interface” on the actuator laptop 14B₂ can also be a graphical user interface (“GUI” interface) 40 on a screen 50 that can provide more options and features to the manager to control the messaging being sent by a manager. The manager/coach can use a mouse or keypad to select the types of pitches. Alternatively, the manager or coach may use his or her finger on the touchscreen of the actuator tablet 14B₁. As with the tablet embodiment shown in FIG. 8, the GUI interface 40 on the actuator 14B₂ can be used to call pitches in situations when the managers call the pitches. The manager/coach can push different buttons A₁-A₆ to call different pitches on one side of the plate or different buttons D₁-D₆ to call those different pitches on the other side of the plate with both the pitcher and the catcher as well as possibly other players in the field receiving the signal on their indicators 12 (as shown in FIG. 2) of what pitch is being thrown. The GUI interface 40 on the laptop device 14B₂ can also be used by the manager to signal fielders to let them know where to be in a shift in the infield or outfield. In this embodiment, with the number of pitches provided, the GUI interface may not be pitcher specific, but could be generically used with all the pitchers in the bull pen or on the team.

To transmit the signal data, the system 10 may include any number of wireless communication setups to enable wireless transmission between indicator(s) 12 and actuator(s) 14 of the various participants. The signal data may be encrypted using any number of cryptographic or other encryption techniques, including but not limited to frequency hopping, time shifting, rotating key encryption and/or other private/public key encryption methods. For example, some encryption methods may only prevent decryption for very short periods of time, but such time may be longer than is needed for the signals to be acted upon, and therefore the encryption is effective to prevent an opposing team from preemptively reacting to such signals. In some embodiments, the encryption code used on the signals can be changed every few seconds and is virtually impossible to hack. When more than two participants are enabled with actuators 14 and/or indicators 12 of the system 10, a mesh network may be provided for enabling low-cost communications over short distances. The wireless mesh infrastructure may include a network of transmitters 34 and receivers/transceivers 24 housed in either or both indicators 12 and actuators 14. Transmission of signal data may occur from an originating actuator 14 to other indicator(s) 12 and/or actuator(s) 14 before finally being transmitted to the intended indicator 12. These intermediate indicator(s) 12 and/or actuator(s) 14 may boost a strength of the transmission and the intermediate indicators 12 can also be recipients of the signal data as well.

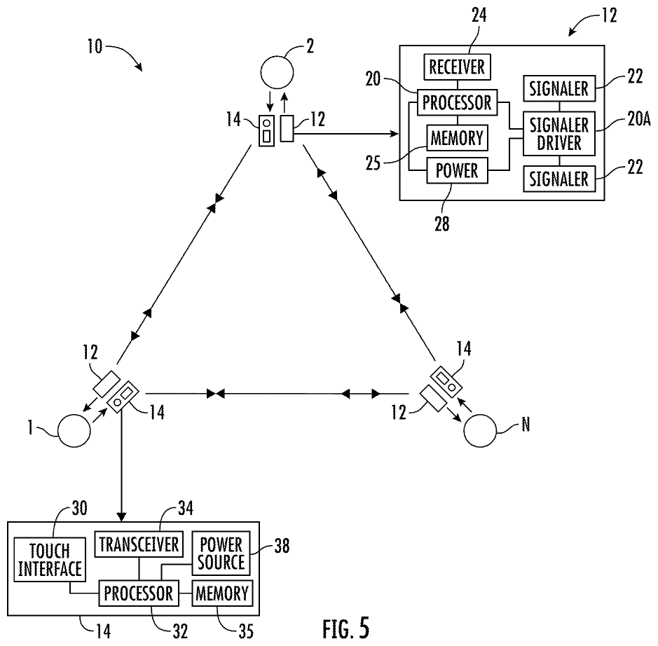

Thus, referring to FIG. 5, a schematic of the operation of an actuator 14 by a first participant 1 and an indicator 12 by a second participant 2 within a signal communication system 10 is shown that includes a detailed schematic of both an indicator 12 and an actuator 14. The first participant 1 and the second participant 2 as well as any number of other participants N can have both an actuator 14 and an indicator 12. For example, in the context of baseball, the first participant 1 can be a catcher with the actuator 14 secured to an article of apparel from which the catcher can discreetly send a signal, while the second participant 2 can be a pitcher and/or other players the field with the indicator 12 secured to an article of apparel, such as a baseball cap. When the first participant 1 wants to provide a signal to the second participant 2 or other participants N, the first participant 1 can press a touch interface 30 to send a signal. Upon the pressing of the touch interface 30, the touch interface 30, which is in operable communication with an actuator processor 32 in the actuator 14, can send the signal of the button press to the actuator processor 32. In some embodiments, the actuator processor 32 can be in communication with the memory 35 and can generate wireless signal data that can be sent via wireless communication 70 by a transmitter, or transceiver, 34 using a mesh network technology within a proximity range of the actuator 14. The indicators 12 can receive the wireless signal data if it is within the proximity range of the actuator 14. In particular, in some embodiments, an indicator processor 20 can receive the wireless signal data and convert the wireless signal data using at least one of software or algorithms stored in memory 25 to an indicator data, such as a haptic signal which the indicator processor 20 sends to a signaler driver 20A, which, in some embodiments, can be incorporated into the indicator processor 20 or, in other embodiments, can be a separate driver. The signaler driver 20A can, in turn, send the indicator data to the signaler(s) 22 that are in either direct or indirect contact with the respective second participant 2 or other participants N. The signaler 22 receiving the indicator data can generate haptic feedback, such as a vibration, that the respective second participant 2 or other participants N can feel thereby generating a transfer of information to the respective second participant 2 or other participants N from the first participant 1.

For example, different number of button presses can create a corresponding discrete number of wireless signals that are received by the indicator processor 20 and converted into a corresponding number of discrete haptic signals that the different signalers 22 provide to the respective second participant 2 or other participants N. The different number of signals can convey different information from the first participant 1 to the respective second participant 2 or other participants N. For instance, the first participant 1 can discretely press the touch interface 30, for example, 1-2-3-4-5 times with each grouping of number of signals conveying different information to the respective second participant 2 or other participants N.

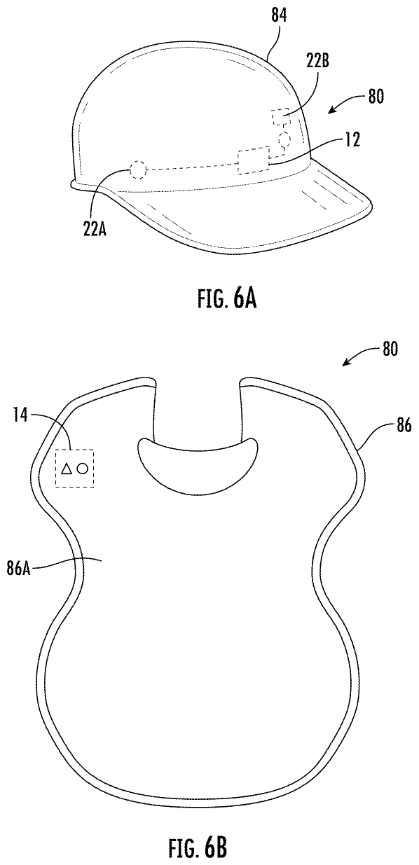

As stated above, the signaling system, or signal communication system, 10 may be configured to be engaged with, coupled to, and/or included in a variety of apparel 80, including but not limited to hats, helmets, shirts, pants, mitts or gloves, sweatbands, chest protectors and/or other athletic gear. In some embodiments, the indicator 12 may be positioned in a hat, sweatband, or shirt of a baseball pitcher for relaying signals from other participants 1 as shown in FIGS. 3B and 6A. The indicator 12 may include at least two signalers 22A, 22B, which may be positioned a distance apart in the apparel 80. Different information based on the number signals received and the signaler 22A, 22B that creates the corresponding haptic feedback can be assigned to the different combinations by the participants. As shown in FIG. 6A, the indicator 12 can be incorporated into the hat 84. For example, the indicator 12 can be sewn into the headband of the hat 84.

Similarly, in some embodiments, the actuator 14 can be attached to, positioned on or in, or included in the shirts, pants, mitts or gloves, chest protectors and/or other athletic gear of a first participant. For example, in some embodiments where the signaling system 10 is used in baseball, the actuator 14 can be attached to, positioned on or in, or included in the chest protector 80B, 86 used by a catcher as shown in FIGS. 4D and 6B. As shown in FIG. 6B, the actuator 14 can be incorporated into a rear side 86A of the chest protector 86. For example, the actuator 14 can be sewn into the rear side 86A of the chest protector 86.

In some embodiments, the indicator 12, actuator 14 and/or signaler(s) 22 may include a clip for engaging, or a fastener for coupling, the indicator, actuator, or signaler with the apparel 80. For example, the actuator 14 may include a clip for engaging the actuator 14 on the interior of a catcher's chest protector 80B as shown in FIG. 4D so that the catcher may covertly interact with the buttons for sending signals to the pitcher.

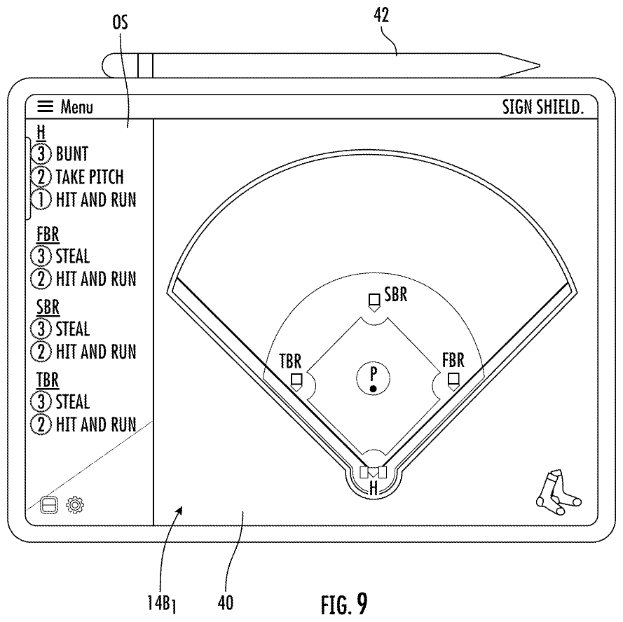

Referring to FIG. 9, as an additional aspect of the signaling system 10 as used in baseball, when the team is on offense, the GUI interface 40 on a tablet device actuator 14B₁ can be used to signal batters and/or runners when to bunt, steal a base, take a lead off a base, etc. As shown in FIG. 9, the GUI interface can provide a GUI button options such as pushing the button “3” to indicate that a batter at the plate should try to bunt. For example, manager pushes the GUI button “3” under the hitter heading “H” a signal can be sent to the indicator being worn by the batter that can vibrate appropriately to indicate to the batter that he should try to bunt. Similarly, an appropriate GUI button can be engaged to indicate to the batter to take a pitch or hit and run as an example. Additionally, a GUI button for a sacrifice fly (not shown) can be provided. Further, a signal can be sent to the indicator being worn by a runner at first base, second base, or third base, indicating that they such run on a hit, but selecting “HIT AND RUN” or steal a base depending on the GUI button that is pushed for the perspective runner. The signaling system 10 can be programmed to meet the needs of the team or user as needed. Thus, the actuators 14B with the GUI interface 40 can provide more options to the manager. As above, the tablet 14B₁ can be a touchscreen device, such as an iPAD®, Microsoft Surface®, Android® tablet device, or the like. Alternatively, the actuator can be a laptop computer.

While the present signaling systems and methods are described in reference to baseball. This signaling system technology has broader applications with a variety of other potential cost savings uses. For example, the signaling systems and components can be used in industrial applications in which the visibility is poor, or the noise level is high. These devices and signaling systems can be used to signal workers for various reasons such as assigning them to another machine, signaling break or lunch time, or notification of an emergency situation within an industrial facility. The signaling system has military applications as well. The signaling system can be used in military helmets or other headgear to provide coded signals that are encrypted to direct troop movement during a mission as mission objectives and targets change. Another example of a different use of the signaling system include medical applications such as in intensive care units as a means for patients to communicate with nursing stations to provide notice of their needs of a medical emergency. Additionally, severely disabled persons could use this device to communicate with their health care providers as to what their needs are. Further, there are other sports related applications, including using the signaling system disclosed herein for calling out plays to teams in any team sport such as football, hockey, soccer, NASCAR, etc. Thus, the signaling system 10 can be programmed to meet the needs of the team or user as needed. Thereby, the application of the signaling system 10 is very versatile.

These and other modifications and variations to the present subject matter may be practiced by those of ordinary skill in the art, without departing from the spirit and scope of the present subject matter, which is more particularly set forth herein above and any appending claims. In addition, it should be understood the aspects of the various embodiments may be interchanged either in whole or in part. Furthermore, those of ordinary skill in the art will appreciate that the foregoing description is by way of example only and is not intended to limit the present subject matter.

What is claimed is:

1. A signaling system comprising:
one or more indicators with each indicator comprising one or more signalers, an indicator processor, and a wireless transceiver;
one or more actuators with each actuator comprising a touch interface, an actuator processor, and a wireless transceiver, the actuator processor of each actuator being configured to produce signal data for wireless transmission, and
wherein the indicator processor is configured to electronically communicate with the signaler based on the signal data received by the wireless transceiver; and
the one or more indicators and the one or more actuators being configured to operate as a mesh network that permits the transmission of an originated signal from an originating actuator of the one or more actuators between the indicators and the actuators within a proximity range of each other such that the one or more indicators receive the originating signal even if the indicators are not in a receiving range of the originating actuator.

2. The signaling system of claim 1, wherein the one or more signalers of the indicator includes at least two signalers positioned a distance apart in the apparel of the first participant.

3. The signaling system of claim 1, wherein each signaler of the one or more indicators provides haptic feedback when a signal is sent to the signaler.

4. The signaling system of claim 3, wherein each signaler of the one or more indicators comprises a vibrator.

5. The signaling system of claim 1, wherein each of the indicator and the signaler is housed in a waterproof covering.

6. The signaling system of claim 1, wherein an actuator of the one or more actuators comprises a clip for engaging the actuator with the apparel of the second participant.

7. The signaling system of claim 1, wherein an actuator of the one or more actuators comprises a smart device.

8. A signaling system comprising:
a first article of apparel worn by a first participant, the first article of apparel comprising an indicator positioned therein, the indicator including one or more signalers, an indicator processor, and a wireless receiver;
a second article of apparel worn by a second participant, the second article of apparel comprising an actuator accessibly positioned to a second participant when the second participant is wearing the second article of apparel, the actuator including one or more touch interfaces, an actuator processor, and a wireless transmitter,
wherein the actuator processor is configured to produce signal data for wireless transmission, and
wherein the indicator processor is configured to electronically communicate with the signaler based on the signal data received by the wireless receiver.

9. The signaling system of claim 8, wherein:
the first article of apparel comprises a hat;
the indicator is positioned between an interior sweatband of the hat and the exterior of the hat; and
the one or more signalers comprise a first vibrator positioned on a left side of the hat and a second vibrator positioned on a right side of the hat.

10. The signaling system of claim 9, wherein one or more touch interfaces of the actuator comprises a first touch interface that represents a first side of home plate and a second touch interface that represents a second side of home plate, wherein the first touch interface causes the first vibrator to vibrate when activated and the second touch interface causes the second vibrator to vibrate when activated.

11. The signaling system of claim 8, wherein the touch interface comprises a capacitive touch sensor.

12. The signaling system of claim 8, wherein the touch interface comprises a push-button.

13. The signaling system of claim 8, wherein at least one of the actuator and/or the touch interface is housed in a waterproof covering.

14. The signaling system of claim 8, wherein the second article of apparel comprises a chest protector of a catcher.

15. The signaling system of claim 8, wherein the actuator comprises a clip for engaging the actuator with the second article of apparel of the second participant.

16. The signaling system of claim 8, further including an indicator power source for providing power to the indicator, and an actuator power source for providing power to the actuator.

17. The signaling system of claim 8, wherein the actuator includes memory for storing the signal data.

18. The signaling system of claim 8, wherein the indicator comprises one or more flex circuits for internal electrical communication and processing.

19. The signaling system of claim 8, wherein the data signals are encrypted, and the wireless receiver is configured to frequency hop.

20. The signaling system of claim 8, wherein the wireless receiver of the indicator and the wireless transmitter of the actuator comprise transceivers.

21. A method of operating the signaling system, the method comprising
providing an actuator with a touch interface operated by a first participant;
providing an indicator used by a second participant;
receiving data from a touch interface converting haptic data received from a button into signal data;
wirelessly transmitting the signal data from the actuator to the indicator;
converting the signal data into indicator data by the indicator;
transmitting the indicator data to a signaler of the indicator; and
activating the signaler using the indicator data to provide a message to the second participant.

22. The method of claim 21, wherein activating the signaler using the indicator data provides a vibration signal as a message to the second participant.
